(19) United States
(12) Patent Application Publication
(10) Pub. No.: US 2006/0198124 A1
(43) Pub. Date: Sep. 7, 2006

(54) Hurricane door light, door, and method of assembling the light

(76) Inventor: Gavin Copland, Langley (CA)

Correspondence Address: BERENATO, WHITE & STAVISH, LLC, 6550 ROCK SPRING DRIVE, SUITE 240, BETHESDA, MD, 20817, US

(21) Appl. No.: 11/360,999

(22) Filed: Feb. 24, 2006

Related U.S. Application Data
(60) Provisional application No. 60/655,418, filed on Feb. 24, 2005.

(51) Int. Cl. F21S 8/00

(52) U.S. Cl. 362/145

(57) ABSTRACT

A door light and associated frame designed to withstand the effects of a hurricane. The door light has a laminated translucent panel that is held in place by two adjoining frame members. The first frame member has a grooved portion. The second frame member is positioned opposite the first frame member and has a tongue portion that extends into the grooved portion. A connector extends into the tongue portion and expands the tongue portion so that a frictional fit is formed between the tongue portion and the grooved portion, thereby securing the laminated translucent panel between the first and second frame members.

### CROSS-REFERENCE TO RELATED APPLICATION AND CLAIM TO PRIORITY

This application is a non-provisional application of provisional application Ser. No. 60/655,418, filed Feb. 24, 2005, the disclosure of which is incorporated herein by reference and to which priority is claimed.

### FIELD OF THE INVENTION

The invention relates to a door light and associated frame members designed to withstand the effects of a hurricane. The invention also relates to a method of making a door light and the resulting door.

### BACKGROUND OF THE INVENTION

The prior art includes multiple door lights and associated frames. In the past, the prevailing design consideration for most commercially available door lights has been appearance and basic fit with the associated door. However, the door light is an important part of the protective barrier between the exterior of a house and the house's interior.

In the event to a severe storm or a hurricane, the atmospheric pressure of the interior of a house or dwelling is much greater than the pressure outside the house. If a breach occurs in the house's protective barrier, the pressure within the house seeks to immediately equalize with the pressure outside the house, resulting in an explosive reaction that may cause severe structural damage to the house, and leave the house's interior vulnerable to further damage. Because conventional door lights are relatively easily broken or breached by flying debris, storm damage associated with conventional door lights is relatively common and costly.

The damage done by severe storms and hurricanes has prompted officials and insurance companies in coastal areas to establish standards that apply to “glazed units”, including door lights. The standards are designed to determine whether a door light is capable of withstanding the effects of a hurricane or tornado. The Testing Application Standard 201-94 (TAS 201) test is designed to test a product's resistance to windborne debris. To pass the test, the units must withstand a Large Missile Impact test. The missile used in the test is a 7-9 foot Southern Yellow Pine 2×4. The missile is placed 17 feet from the tested unit, and launched so that the missile attains a speed of 35 miles per hour (50 feet/second) before impacting the target face of the unit.

After the TAS 201 test is performed, a TAS 203-94 (TAS 203) test is performed. The same glazed panel is used for the TAS 201 test and the TAS 203 test. The TAS 203 test is designed to evaluate a product's resistance to cyclic pressure differentials that may occur when a hurricane passes. The glazed panel has pressure applied to a first side at varying cycle pressures. Next, the same side has a vacuum cyclically applied. Glazed units for doors will undergo a total of 9000 cycles during the TAS-203 test.

Although door lights are currently available that are designed to pass the TAS 201 and TAS 203 tests, these door lights require precisely drilled translucent panels and special frames that must be aligned with the panels during the installation process. As a result, the currently available hurricane door lights are relatively difficult to manufacture and install.

The need exists for a hurricane door light that passes the TAS 201 and TAS 203 tests, is relatively easy to manufacture and install, and requires no specially drilled translucent panels. The current invention is a hurricane door light that meets the requirements of TAS 201 and TAS 203 and includes a flexible tongue and groove design that is easy to install and requires no drilled translucent panels.

### SUMMARY OF THE INVENTION

The present invention comprises a door light with a laminated translucent panel. A first frame member with a grooved portion extends along at least a first edge of the panel. A second frame member extends along the panel opposite the first frame member. The second frame member includes a tongue portion that extends into the grooved portion of the first frame member. At least a first connector extends into and expands the tongue portion so that the tongue portion and the grooved portion are intersecured.

The present invention also comprises a door that includes a door slab with an opening and a laminated translucent panel disposed within the opening. A first frame member with a grooved portion extends about the periphery of the opening along a first side of the slab. A second frame member extends about the periphery of the opening along an opposite side of the slab. The second frame member has a tongue portion that extends into the grooved portion. At least a first connector extends into and expands the tongue portion so that the tongue portion and the grooved portion are frictionally intersecured.

The invention also comprises a method of making a door light. A translucent panel is provided. A first frame member that has a grooved portion is positioned along an edge of the panel. A second frame member that has a tongue portion is positioned opposite the first frame member. The tongue portion of the first frame member is placed into a groove portion of the second frame member so that the tongue expands into engagement with the groove, and thereby frictionally intersecures the first and second frame members to the panel.

### BRIEF DESCRIPTION OF THE DRAWINGS

FIG. 1 is a fragmentary cross-sectional view of the present invention.

FIG. 2 is a fragmentary cross-sectional view of the present invention with a connector in place.

FIG. 3 is a plan view of the interior side of the panel installed in the frame members.

FIG. 4 is a plan view of the panel and frame installed in a door.

### DETAILED DESCRIPTION OF THE INVENTION

The current invention is a door light 8 that is designed to withstand hurricane conditions, a method of making the door light 8, and a door resulting from the installation of the light 8. The door light 8 is comprised of a laminated translucent panel 14 that is held in place by a first frame member 10 and a second frame member 12. The first 10 and second 12 frame members and the translucent panel 14 may be comprised of any material known in the art. The translucent panel 14 may be designed in any configuration known in the art.

In the preferred embodiment, the first frame member 10 is disposed on the interior side 16 of the panel 14 and an associated door slab 15, and the second frame member 12 is disposed opposite the first frame member 10 on the exterior side 18. In this application, the “interior” side or face 16 refers to the portion of the door 15 and panel 14 which face inside the structure on which the door 15 is installed. The “exterior” side or face 18 is opposite the interior side or face 16, and refers to the portion of the panel 14 and door 15 which face away from the structure on which the door 15 is installed. The exterior face 18 of the panel 14 and door 15 is subject to the effects of weather

In the preferred embodiment, the first 10 and second 12 frame members are comprised of extruded aluminum alloy (6000 series), preferably having a nominal thickness of 0.060 inches. The panel 14 is a sealed unit that is 1.25 inches thick. The panel 14 includes a 3 mm tempered clear glass outer pane 20, and an 8 mm laminated inner layer 22. The outer pane 20 is positioned on the exterior side 18 of the panel 14. The laminated inner layer 22 is positioned on the interior side 16 of the panel 14, and is preferably comprised of two clear panes 23, 27 and a polymeric layer 25 adhesively secured between the pane 23 and pane 27. The panes 23 and 27 may be clear glass, tempered glass, polycarbonate, or the like. The polymeric layer 25 is preferably comprised of polyvinylbutylene (PVB).

The panel 14 includes a notched space bar 24 that rests on compound sealant 26. The space bar 24 supports a beveled decorative glass pane 30, such as a bevel cluster. The beveled portion 32 of the decorative glass pane 30 generally faces the exterior side 18 of the panel 14. The decorative glass pane 30 typically has a shape corresponding to the shape achieved with the frame members 10, 12. Additionally, the decorative glass pane 30 may have colored components, as may be desired.

The first 10 and second 12 frame members include first 34 and second 36 panel support portions for laterally supporting the interior 16 and exterior 18 sides of the panel 14. A sealant 38 is disposed between the first panel support portion 34 and the interior face 16 of the panel 14. The sealant 38 is also disposed between the second panel support portion 36 and the exterior face 18 of the panel 14. In the preferred embodiment, the sealant 38 is DOW 832 silicone sealant. The sealant 38 serves to keep water from migrating into the interior of the panel 14 and also prevents rattling of the panel 14 against the metallic frame members 10, 12 as might otherwise occur.

The first 10 and second 12 frame members also include first 40 and second 42 door support portions. The first door support portion 40 is disposed adjacent an interior face 16 of the door 15, and the second door support portion 42 is disposed adjacent the exterior face 18 of the door 15. A sealant 48 is used to create a seal between the first door support portion 40 and the door 15, and between the second door support portion 42 and the door 15.

A grooved portion 50 of the first frame member 10 extends between the panel 14 and the door 15, along the peripheral edge of the panel 14. The upper surface of the grooved portion 50 abuts the bottom of the panel 14, and the lower surface of the grooved portion 50 abuts the top of the door 15. In the preferred embodiment, inwardly-facing surfaces 52 of the grooved portion 50 are textured so that the surfaces 52 are serrated.

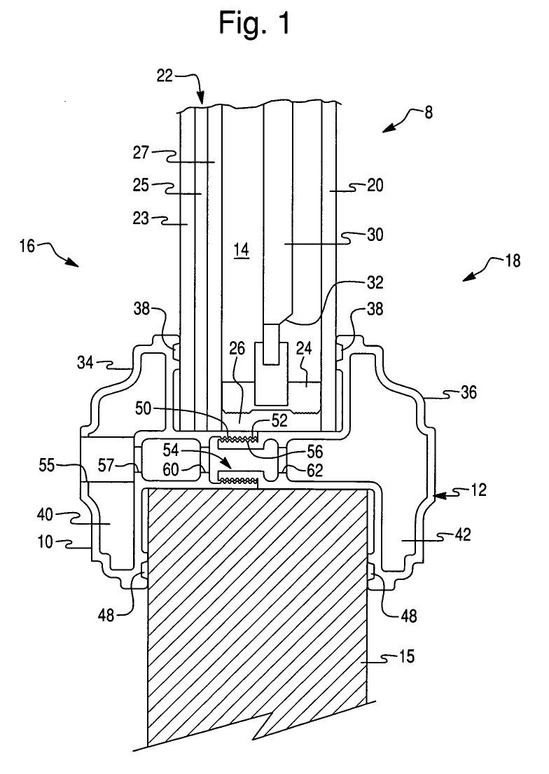

A tongue portion 54 of the second frame member 12 also extends between the panel 14 and the door 15. The upper surface of the tongue portion 54 abuts the bottom of the panel 14, and the lower surface of the tongue portion 54 abuts the top of the door 15. The tongue portion 54 supports the exterior side 18 of the panel 14. The tongue portion 54 includes outwardly-facing surfaces 56 that are disposed adjacent to the inwardly-facing surfaces 52 of the grooved portion 50. In the preferred embodiment, the outwardly-facing surfaces 56 of the tongue portion 54 are textured so that the surfaces 56 are serrated. As can be seen in FIG. 1, the grooved portion 50 has a length exceeding the height of the tongue portion 54. The grooved portion 50 has an edge that abuts a shoulder of the tongue portion 54, thus providing a positive stop for locating first frame member 10 relative to second frame member 12. In addition, the grooved portion 50 and tongue portion 52 thus provide a continuous surface supporting the panel 14.

As best shown in FIG. 1, the tongue portion 54 of the second member 12 fits inside the grooved portion 50 of the first member 10 so that the tongue portion 54 and the grooved portion 50 overlap to support the center portion of the panel 14. An outer opening 55 is formed in the outer surface of the first member 10. The outer opening 55 is aligned with first 57, second 60, and third 62 inner openings. The first 57 and second 60 inner openings are formed in the grooved portion 50 of the first frame member 10, and the third inner opening 62 extends from the tongue portion 54 into an interior portion of the second frame member 12. In the preferred embodiment, the outer opening 55 has a 5/16 inch diameter, and the inner openings 57, 60, 62 have a ⅛ inch diameter. The openings 55, 57, 60, 62 are preferably drilled into the first 10 and second 12 frame members.

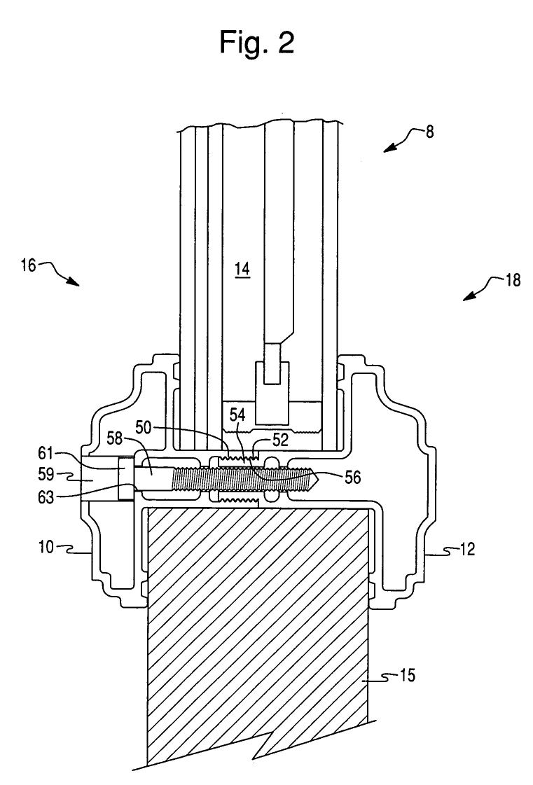

As best shown in FIGS. 1 and 2, a connector 58, preferably a threaded pan head screw, is inserted into the outer opening 55 in the first frame member 10, and extends through the first 57 and second 60 inner openings, and into the third inner opening 62 in the second frame member 12. When the connector 58 is in the fully installed position (as shown in FIG. 2), the head 61 of the connector 58 abuts an interior surface 63 of the first frame member 10. As those skilled in the art recognize, a screw, such as is used for connector 58, has a tapered profile. As the connector 58 is rotated and penetrates the tongue portion 54, the tongue portion 54 is expanded outwardly so that the outwardly-facing serrated surfaces 56 of the tongue portion 54 contact the inwardly-facing serrated surfaces 52 of the grooved portion 50. When the installation of the connector 58 is complete, the inwardly-facing serrated surfaces 52 of the groove portion 50 are locked with the outwardly-facing serrated surfaces 56 of the tongue portion 54, so that there is an interlocking connection between the first member 10 and the second member 12. The panel 14 is thus secured to the door 15 by the frictionally and mechanically connected first 10 and second 12 members. After the connector 58 is installed, a plug 59 is inserted into the outer opening 55 so that the head 61 of the connector 58 is not visible.

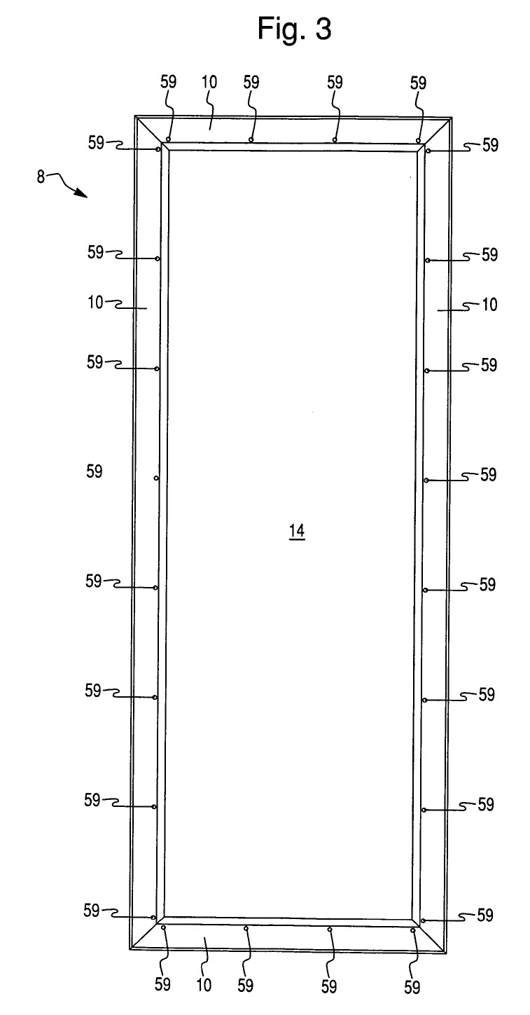

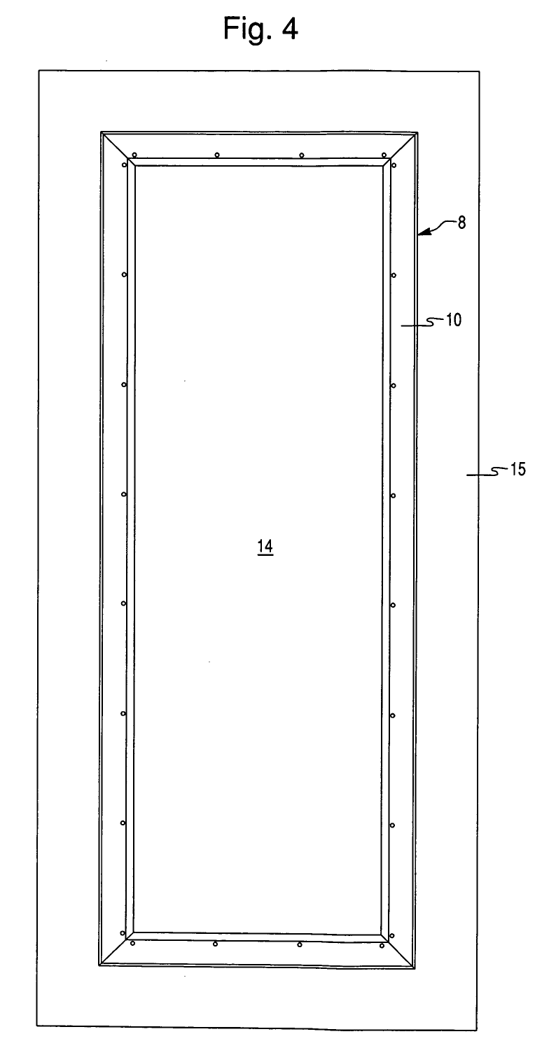

As best shown in FIGS. 2, 3, and 4, the frame connectors 58 (shown in FIG. 2) and associated plugs 59 are inserted in spaced intervals around the periphery of the panel 14. In the preferred embodiment, the connectors 58 are generally spaced 9 inches apart. Although the door light 8 of the preferred embodiment is rectangular and installed in a door 15, in alternative embodiments, the door light 8 may have be of any size and shape known in the art and may also be installed as a side light, a transom light, or in a similar application.

From the foregoing description it is clear that the current invention describes an inventive hurricane door light that passes the TAS 201 and TAS 203 tests, and is easy to manufacture and install. The invention may be modified in multiple ways and applied in various technological applications. It is understood that while various preferred designs have been used to describe this invention, the invention is not limited to the illustrated and described features. For example, while the materials that are used to construct the components of the invention have been generally described, they may include any materials known in the art that are consistent with the function of the described component.

Modifications, usages and/or adaptations following the general principles disclosed herein are included in the present invention, including such departures that come within known or customary practice in the art to which this invention pertains. The present invention is intended to encompass all such departures having the central features set forth above, without departing from the scope and spirit of the invention, and which fall within the scope of the appended claims.

I claim:

1. A door light, comprising:
a laminated translucent panel,
a first frame member extending along at least a first edge of said panel, said first frame member including a grooved portion,
a second frame member extending along said panel opposite said first frame member, said second frame member including a tongue portion extending into said grooved portion, and
at least a first connector extending into and expanding said tongue portion so that said tongue portion and said grooved portion are frictionally intersecured.

2. The door light of claim 1, further comprising a door having an opening, said panel being disposed within said opening, said first frame member extending around a periphery of said panel between said panel and said door, said second frame member extending around a periphery of said panel between said panel and said door on an opposite side of said door from said first frame member.

3. The door light of claim 2, wherein said first frame member is disposed on an interior side of said door, and said second frame member is disposed on an exterior side of said door.

4. The door light of claim 3, wherein there are a plurality of connectors, each of said connectors being inserted through said first frame member and into said tongue portion.

5. The door light of claim 1 wherein said door light has inwardly-facing textured surfaces and said tongue portion has outwardly facing textured surfaces.

6. The door light of claim 1 wherein said grooved portion has inwardly-facing serrated surfaces and said tongue portion has outwardly-facing serrated surfaces.

7. The door light of claim 4 wherein said first frame member includes a first panel support portion for laterally supporting an interior face of said panel, and,
said second frame member includes a second panel support portion for laterally supporting an exterior face of said panel.

8. The door light of claim 7, further comprising a sealant disposed between said first panel support portion and said interior face of said panel, and,
said sealant is disposed between said second panel support portion and said exterior face of said panel.

9. The door light of claim 8, wherein said sealant is a silicone compound.

10. The door light of claim 9, wherein said grooved portion abuts said edge of said panel, and
said tongue portion abuts said grooved portion.

11. The door light of claim 10 wherein said first frame member includes a first door support portion being connected to and extending opposite said first panel support portion, said first door support portion extending perpendicular to said groove portion.

12. The door light of claim 11, wherein said second frame member includes a second door support portion connected to and extending opposite said second panel support portion, and disposed opposite said first door support portion, said second door support portion extending perpendicular to said tongue portion.

13. The door light of claim 12, wherein said first door support portion is disposed adjacent to the interior side of said door, and said second door support member is disposed adjacent the exterior side of said door.

14. The door light of claim 1, wherein said first frame member and said second frame members are comprised of metal.

15. The door light of claim 14, wherein said first and second frame members are comprised of aluminum.

16. The door light of claim 2, wherein said panel includes a laminated inner layer, said laminated inner layer is comprised of a polymeric layer adhesively secured between two adjoining layers.

17. The door light of claim 16, wherein said panel includes a decorative pane.

18. The door light of claim 17, wherein said panel includes an outer pane, said decorative pane being positioned between said laminated inner layer and said outer pane.

19. The door light of claim 18, wherein said decorative pane comprises a bevel cluster.

20. The door light of claim 2, wherein a first side of said grooved portion abuts said panel and a second side of said grooved portion abuts said door, and,
a first side of said tongue portion abuts said panel, and a second side of said tongue portion said door.

21. The door light of claim 20 wherein said tongue portion extends into said grooved portion so that said grooved portion overlaps said tongue portion to support a center portion of said panel.

22. The door light of claim 1 wherein said first and second frame members extend around a periphery of said panel.

23. The door light of claim 1, wherein said first frame member is connected with said second frame member so that said door light passes the TAS 201-94 test.

24. The door light of claim 22, wherein said first frame member is connected with said second frame member so that said door light successfully passes the TAS 203-94 test after the TAS 201-94 test.

25. The door light of claim 1 wherein said connector extends through said tongue portion and into an opening in said second frame member so that said connector secures said first frame member to said second frame member.

26. The door light of claim 1 wherein said connector is a pan head screw.

27. The door light of claim 3 further comprising an opening in an outer surface of said first frame member, and a plug fitting within said opening,
wherein said connector has a head portion, said opening being larger than said head so that said head passes through said opening when said connector is installed in said tongue portion, said head abutting an interior surface of said first frame member when said connector is installed in said tongue portion, said plug being larger than said head, said plug being positioned in said opening after said connector is installed so that said head is not visible from the interior side of said door.

28. A door, comprising:
a door slab having an opening therein,
a laminated translucent panel,
a first frame member extending about the periphery of said opening along a first side of said slab, said first frame member including a grooved portion,
a second frame member extending about the periphery of said opening along an opposite side of said slab, said second frame member having a tongue portion extending into said grooved portion, and,
at least a first connector extending into and expanding said tongue portion so that said tongue portion and said grooved portion are frictionally intersecured.

29. A method of making a door light, comprising the steps of:
providing a laminated translucent panel,
positioning a first frame member having a groove along an edge of the panel,
positioning a second frame member having a tongue opposite the first frame member,
placing the tongue portion into the groove portion,
expanding the tongue into engagement with the groove and thereby frictionally intersecuring the first and second frame members to the panel.
